(19) United States
(12) Patent Application Publication
(10) Pub. No.: US 2026/0002362 A1
(43) Pub. Date: Jan. 1, 2026

(54) AUTOMATED OPTIMIZED STORMWATER ROOF RETENTION SYSTEMS WITH INTEGRATED LEAK DETECTION

(71) Applicant: SUSTAINABLU, LLC, Milwaukee, WI (US)

(72) Inventor: Anthony MAYER, Milwaukee, WI (US)

(21) Appl. No.: 19/253,123

(22) Filed: Jun. 27, 2025

Related U.S. Application Data
(60) Provisional application No. 63/664,955, filed on Jun. 27, 2024.
(60) Provisional application No. 63/719,615, filed on Nov. 12, 2024.

(51) Int. Cl. E04D 13/04; E03F 1/00; E04D 13/00; G05D 7/06

(52) U.S. Cl. CPC E04D 13/0409; E03F 1/00; E04D 13/006; G05D 7/0623; E04D 2013/0427

(57) ABSTRACT

In an exemplary embodiment, a system for releasing stormwater on a rooftop of a building structure includes at least one drain water retention device including a float control device to measure volumetric stormwater retained in the rooftop and a valve to operatively open a drain when the measured volumetric stormwater is exceeded, at least one leak detection device configured to detect a water leak, located under an underlying surface of the rooftop, the at least one leak detection device detects the leak in response to change in relative humidity levels or dew point under the underlying surface of the rooftop, and a controller, executing control instructions, in communication with the at least one drain water retention device for selectively controlling the valve in accordance with the control instructions, the controller includes a storage associated with the controller for storing the control instructions. The control instructions are performed according to the steps of measuring the volumetric stormwater retained in the rooftop, determining a duration of time of stormwater retained in the rooftop, determining a location of the building structure to provide prior estimated precipitation and atmospheric conditions, defining a predefined allowable tolerance, and comparing the measured volumetric stormwater with the predefined allowable tolerance and, if the measured volumetric stormwater exceeds the predefined allowable tolerance, opening the drain to remove the stormwater.

### REFERENCE TO RELATED APPLICATIONS

This application claims priority to U.S. provisional application 63/664,955, filed Jun. 27, 2024, entitled “Automated Roof Drain Retention System” and U.S. provisional application 63/719,615, filed Nov. 12, 2024, entitled “Automated Optimized Stormwater Roof Retention Systems with Integrated Leak Detection,” the entire contents of both which are hereby incorporated by reference herein.

### TECHNICAL FIELD

The present disclosure relates to a stormwater management system that optimizes the use of surfaces for stormwater retention and detention. More specifically, an automated stormwater management system with leak detection and evaporation effects.

### BACKGROUND

Stormwater management regulations, ordinances, and codes expanded exponentially in the 21^{st} century. Most of these changes were originated from the U.S. Environmental Protection Agency (EPA). The result of this legislation is that requirements to manage stormwater have exponentially increased in the last quarter of a century, while the cost of managing stormwater has also significantly increased. Today, owners and developers spend the highest percentage of their construction and maintenance budgets on stormwater management than they ever have in modern history.

Urban areas have felt the greatest effect, as these spaces have a higher concentration of impermeable surface and are generally more densely developed. In these environments, stormwater has a greater impact, as there is a lower percentage of permeable surfaces (e.g. planted areas), than in outer-ring suburban or rural areas. The density of urban environments prevents the use of many less expensive stormwater management solutions that rural or sprawl communities use, e.g., a retention pond or constructed wetlands. The environmental result is that options for stormwater management for urban environments are limited and expensive.

The problem of optimizing stormwater flow has been addressed in the past. However, others have either provided systems for on-grade/surface applications (which does not fully take into consideration the urban environment) or roof systems incompatible with roofing/waterproofing industry. The on grade/surface applications are too complex and expensive for roof structures, do not take into consideration weather conditions of ponding water on a structural surface and do not meet roofing manufacturer warranty requirements. Roof Systems incompatible with the roofing/waterproofing industry, do not comply with roofing manufacturer requirements, do not take structural capacity into consideration, and do not have a safety mechanism for freeze/thaw conditions.

Therefore, the present disclosure is to provide a stormwater roof retention system with integrated leak detection which is designed to meet all industry and/or regulatory requirements to effectively manage stormwater on a roof surface of a building.

### SUMMARY

In an exemplary embodiment, a system for releasing stormwater on a rooftop of a building structure includes at least one drain water retention device including a float control device to measure volumetric stormwater retained in the rooftop and a valve to operatively open a drain when the measured volumetric stormwater is exceeded, at least one leak detection device configured to detect a water leak, located under an underlying surface of the rooftop, the at least one leak detection device detects the leak in response to change in relative humidity levels or dew point under the underlying surface of the rooftop, and a controller, executing control instructions, in communication with the at least one drain water retention device for selectively controlling the valve in accordance with the control instructions, the controller includes a storage associated with the controller for storing the control instructions. The control instructions are performed according to the steps of measuring the volumetric stormwater retained in the rooftop, determining a duration of time of stormwater retained in the rooftop, determining a location of the building structure to provide prior estimated precipitation and atmospheric conditions, defining a predefined allowable tolerance, and comparing the measured volumetric stormwater with the predefined allowable tolerance and, if the measured volumetric stormwater exceeds the predefined allowable tolerance, opening the drain to remove the stormwater.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a schematic illustration of an automated stormwater roof retention system, according to an example embodiment of the present disclosure.

FIG. 2 is a schematic view of an automated optimized stormwater roof retention system with integrated leak detection, according to an example embodiment of the present disclosure.

FIG. 3 is a display representation showing an exemplary output of a stormwater management system, according to an example embodiment of the present disclosure.

FIG. 4 is a display representation of an exemplary roof surface, according to an example embodiment of the present disclosure.

FIG. 5 is a dashboard of a system characteristics that tabulates stormwater management performance, according to an example embodiment of the present disclosure.

FIG. 6 is a display representation of an estimator tool, according to an example embodiment of the present disclosure.

FIGS. 7A and 7B are images of an automated stormwater roof retention system with integrated leak detection, according to an example embodiment of the present disclosure.

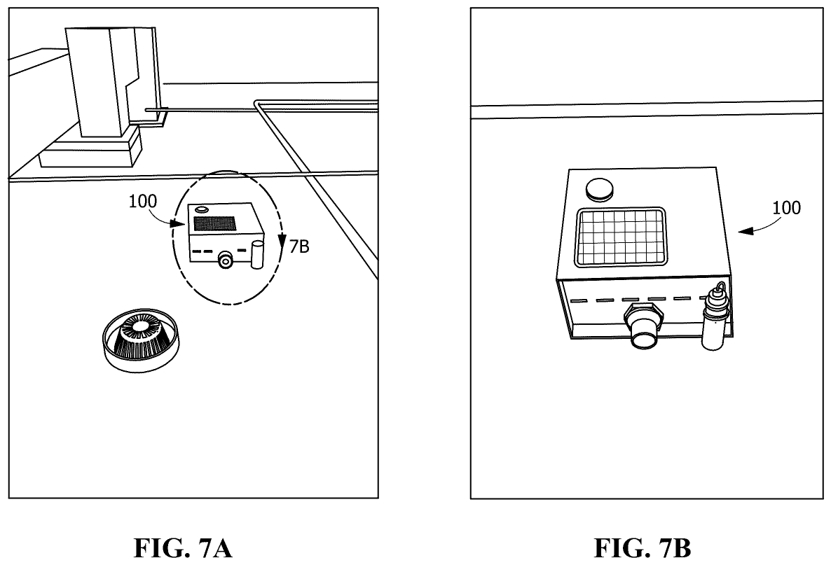

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

The present disclosure enables the use of roof surfaces viable for stormwater management through a system that optimizes the use of such surfaces for stormwater retention and detection.

This is effectively for flat, which in many cases are commercial building roofs, that double as temporary or permanent water retention ponds during heavy storm periods. The system includes a drain that opens/closes in response to measured precipitation events, especially during heavy precipitation. Further, a control system closes the drain to avoid overwhelming municipal stormwater, allowing ponding. When the rain event and/or the conditions that present a risk of overwhelming the municipal stormwater system is over, the drain can be reopened. The control system also takes into account calculated evaporation loss as part of determining when it is safe to open the drain and release water. Moreover, the control system also has leak detection such that if a leak is detected that creates a risk to the underlying structure, the control system will override the closed condition and open the drain. The leak detection system uses either a sensor in the roof substrate (which can also aid in subsequently identifying the location of the leak) or based on detection of water retention anomalies (i.e., comparing a change in the measured depth of the water to a calculated expected value based on measured and/or historic atmospheric conditions for a particular location).

The present disclosure relates to a rainwater collection for a retention/detention roof system. More particularly, the present disclosure relates to an automated roof drain retention system controlled by a leak detection system in which water intended to be stored by the retention/detention roof is automatically flushed through a drain system upon detection of a possible leak.

In an exemplary embodiment, a system includes a drain water retention/detention device, a leak detection device configured to operate the drain water retention/detention device, and a controller for controlling the drain water retention/detention device and the leak detection device. The system is configured to operate through detection of the presence of water in a roof cavity via a central computing unit.

In some implementations, the system detects a predictive algorithm that generates expected stormwater management. For example, the system can utilize the geometry of the roof, such as, square feet of the roof, depth of stormwater, and/or roof drains and slopes of the roof (e.g., ¼″ per foot, etc.) to provide maximum volume capacity.

In some implementations, the system can utilize the location of the roof to predict prior precipitation and atmospheric conditions (i.e., temperature, humidity, wind speed, solar radiation, etc.).

In some implementations, the system can utilize the time the stormwater will be held on the roof before flushing. That is, the system can contain programmable variations that can be configured for the appropriate size of the project. Such conditions can include health code for stagnant water (e.g., 72 hours before flushing) and/or roofing manufacturer ponding water warranties (e.g., 48, 72, etc.). These calculations can simulate an estimated amount of stormwater that is retained and evaporated over a given period of time.

In some implementations, the system can provide constant monitoring of precipitation/atmospheric conditions and volumetric stormwater management levels with a display dashboard providing data that summarizes stormwater management performance.

In some implementations, the system includes a precipitation/atmospheric sensor. Such sensor(s) can be a base sensor that tracks precipitation or an optional add-on sensor(s) for additional evaporation calculation against base line from a float control device. The sensor can measure temperature, solar intensity, humidity and/or wind speed.

In some implementations, the system includes a float control device that measures volumetric retention value at a given point of time. The float control device can be implemented with optional add-on sensor(s) for detecting conditions that exceed conventional evaporation signifying a leak. In some implementations, leak detection may be accomplished using moisture detectors positioned underlying one or more layers of the roof, such as the roof membrane, insulating layers and/or vapor barrier.

In some implementations, the system includes an automated valve for releasing stormwater when retained water is exceeded, retained water exceeds health code regulation, and/or moisture is detected that suggests there may be a leak in the blue roof.

In some implementations, the system includes a wireless computing device to send and receive information relating to at least the precipitation/atmospheric sensor, the float control device, and/or the automated valve. The computing device can be a computing hub or server remotely located. In some implementations, the computing device can include a display for displaying information. The display information may contain off-site hub that controls smart controls and tabulates data, such as, but not limited, all valves per specific project requirements, data to compare to predictive algorithm estimates. In some implementations, the system can send data to system for third party review and analysis.

In some implementations, the system includes a solar powering cell system. The solar powering cell system can control all of the systems described herein, including, but not limited to, the precipitation/atmospheric sensor, the float control device, the automated valve and/or the computing device.

In some implementations, the system can provide constant monitoring of leak detection by analyzing the roofing cavity for consistent dew point. In such a leak detection system, sensors are provided to monitor the roof cavity. For example, a leak detection drain level sensor and a leak detection high water level sensor. It should be appreciated that additional high level water detection sensor(s) can be employed depending on needed per roofing drainage area.

As an exemplary method, the system may test the roofing cavity at selected intervals to create a baseline dew point of each drainage layer roof cavity for 72 hours. Once a dew point baseline is established, the system may be activated. Once the system is activated, the sensors will synchronize with a computing device and operate accordingly. Then the system will check the dew point of each drainage layer at selected interval for anomalous dew point variables. For example, if the dew point is constant, no action will be taken. If dew point increases past the accepted levels as dictated by the roofing manufacturer, the system will flush any retained water existing on the roof and contact the responsible party to make aware what drainage area is affected by the potential breach. The system will check the affected drainage area for potential breach and then repair any potential issue(s).

In some implementations, the present system optimizes the amount of stormwater managed on a roof surface while meeting all construction and code related requirements.

In some implementations, to predict the amount of stormwater managed with the system, an algorithm was developed that takes a building's structural analysis, along with local stormwater regulations, ordinances, codes, and atmospheric data, to provide the most optimized roof stormwater retention system any end user could require.

In some implementations, if the building structure is rated and approved for the live load of the retention roof, the system universally meets any stormwater retention or detention requirement.

In some implementations, providing full transparency on the total stormwater managed, the system tabulates and records real-time data that substantiates the systems claims and further improves the accuracy of the algorithm.

In some implementations, the present system is generally allowed to be installed on roof surfaces that do not have ponding water exclusions in their warranties.

In some implementations, the present system provides options for integrated leak detection, that has the primary function of flushing the roof if a leak is detected. Secondarily to help to remediate the leak, the system notifies all responsible parties of the leak and necessitates a repair of the leak before the system will turn back on. The system will not operate until either the system is back in homeostasis, or the owner reactivates the system.

In some implementations, the automated optimized stormwater roof retention system has a plug-in into “atmospheric controls” of the system in which sensors in the roofing/waterproofing system notify the atmospheric controls if a change in relative humidity of a prescience of water is occurring within the roofing/waterproofing system. The plug-in ties into the substrate of the roofing system, including, but not limited to coverboards, insulation, vapor barriers, concrete decking, etc., identifies a significant change in relative humidity that would indicate the prescience of a leak, flushes the roof, tabulates the vicinity of the location of the leak and notifies the appropriate parties that the roofing/waterproofing surface has an active breach. As a safety feature, the system will not close its valves and retain water until the breach is effectively cured. All events are time stamped and tabulated and available on the project dashboard.

In some implementations, the automated optimized stormwater roof retention system provides the roofing/waterproofing industry with the most conservative approach for on-structure stormwater management. The automated optimized stormwater retention system portion of the device is flexible to meet the full spectrum of structural loading, stormwater retention, stormwater flowrate, health-code and roofing/waterproofing requirements at an extraordinarily high value. The leak detection portion of the system provides peace of mind that when a leak occurs on a roofing/waterproofing surface where stormwater is retained that the retained water is removed as quickly as possible. This safety factor exponentially reduces exposure to both the roofing/waterproofing manufacturers warranting their systems as well as to the owner by mitigating potential damages of such an event.

In some implementations, the programming of the automated optimized stormwater retention system to detect water retention anomalies is also able to also detect leaks. As an example, if a retention roof contains stormwater, that stormwater should evaporate at a rate consistent with current atmospheric conditions. For example, the additional system and method will check if the retained stormwater is disappearing beyond what the high-end reasonable range for evaporation is on a particular day. If this anomaly occurs, it indicates the prescience of a leak, flushes the roof, tabulates the time of the leak and notifies the appropriate parties that the roofing/waterproofing surface has an active breach. As a safety feature, the system will not close until the owner, or owner's representative resets the system to after the breach is remedied, to safely retain stormwater.

An enhanced internal method on further identifying the location of the leak would be through float valves located on all smart controls. If each drain has a float valve, through precision measurements, waves can be identified on a retention roof. Wherever the leak is occurring, this would experience higher frequency waves. That said, in this case, the system could identify what drain's drainage area the breach is coming from. Although not as precise as the constant monitoring leak detection method, it would isolate which part of the roof that the leak is coming from.

In some implementations, an external method of using reactive leak detection (by others through the roofing manufacturer), would allow the pinpointing of the leak, after identified by the methods described herein. This could be attained by either a single float valve per plane or float valves on all smart drains.

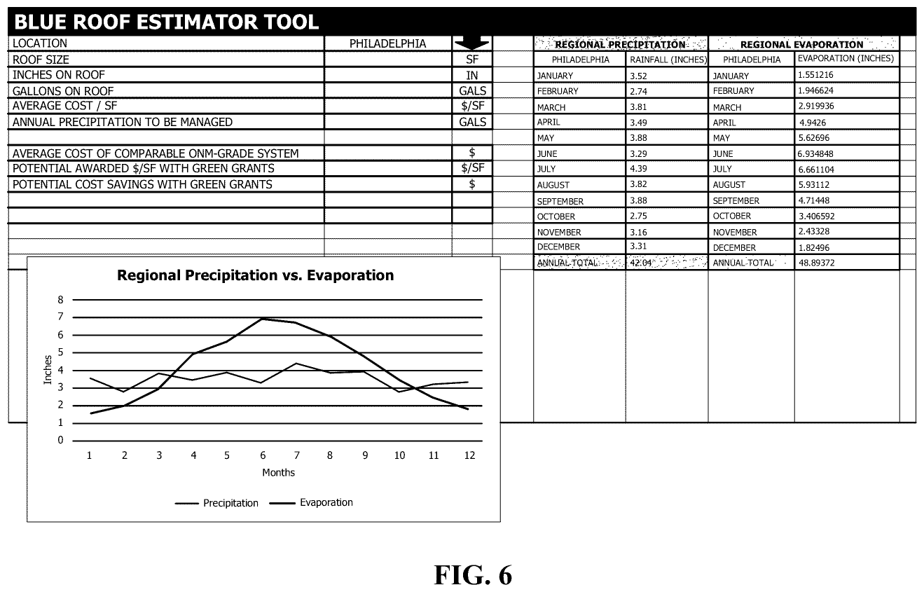

In an exemplary embodiment, the present system provides an expected stormwater management amount over any given point of time. In one example, the system takes roof surface areas and their applicable available depth(s) to retain stormwater. This calculation can be square feet, meters, etc., multiplied by the intended total depth of stormwater retention. Also, the calculation provides volumetric pools with the intention to retain stormwater for a predetermined time on a roof surface, e.g. 24 hours (very short period, not common), 48 hours (not very common—generally seen in the south where mosquitos are of greater issue), 72 hours (the most common as it meets most State and municipal codes for the maximum duration that ponding water can exist) or indefinite (the best option, but not allowed by many States or municipalities). Next, the system takes the volume of stormwater on each roof area and, overlays how long the stormwater can remain on the roof and then adds the location of the project (to project evaporation which provides the estimate of how much stormwater the system can manage). The location helps determine the amount of stormwater that will evaporate based on the volumetric and length of time of the particular roof surface. As an example, the combined area of the roof is 27,000 SF, has an average volume of 4.70″ and the project is Philadelphia, and the time period for releasing any retained stormwater is seventy-two (72) hours-then if there is a precipitation event of greater than 0.1″ in an hour after the initial rainfall but before the 72-hour time expires, the system resets and the 72 hours clock starts all over. That is the amount of agitation that ponding water needs in most areas to abort mosquito larvae and other pathogens. That said, it can be stated that a 72 hour system, if it consistently rains 0.1″ within the 72 hour window that the system will perpetually hold the stormwater on the roof. Then based on historic weather data, including but not limited to, temperature, solar radiation, wind speed, humidity, etc., the system will then predict the amount of evaporation that the system will provide over any given point of time, e.g., 10 minutes to indefinite (see FIG. 6 for example).

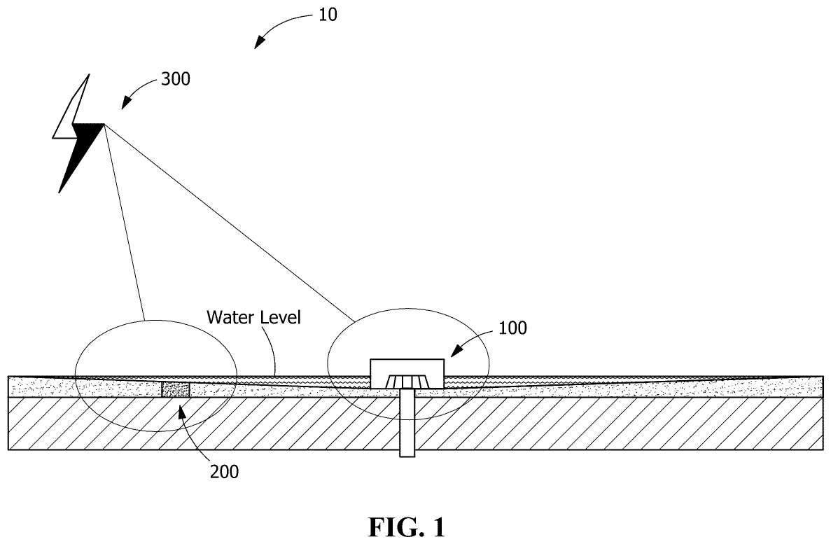

Referring now to the figures, FIG. 1 illustrates an automated roof drain retention system 10, according to an example embodiment. The system 10 includes one or more drain water retention/detention units 100, one or more leak detection units 200 configured to operate in conjunction with the drain water retention/detention unit, and a controller 300 for controlling the drain water retention/detention unit 100 and the leak detection unit 200. The system 10 is configured to operate through detection of the presence of stormwater in a roof cavity via the controller 300. Although not explicitly shown, other plurality of ancillary devices can be included in system 10, such as water conduits, water pumps, water storage drain valves, discharges valves, and the like.

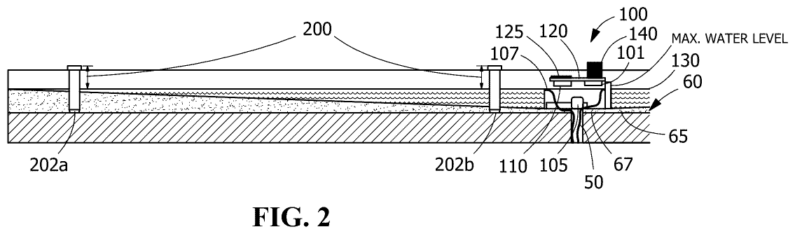

Referring to FIG. 2, the drain water retention/detention unit 100 includes a housing 101 for housing an automated drain valve 105 that is configured to open and close and control stormwater flowing into a rooftop drain 50 located below a rooftop membrane surface 60. Further, the housing 101 seals an area around the roof drain 50 to create the ability to dam/hold stormwater on the roof surface 60 and to house all components/parts of the drain water retention/detention unit 100. In some implementations, the rooftop drain 50 is underneath an insulation layer 65 and/or a vapor barrier layer 67, as shown in FIG. 2. The drain water retention/detention unit 100 operates (i.e., opens/closes) the drain valve 105 to release the stormwater when the stormwater exceeds a predefined level, exceeds health code regulations, and/or detects a leak, which will be described in detail later.

As shown in FIG. 2, the drain water retention/detention unit 100 includes a bypass overflow device 107. By way of example, the overflow device 107 can be an orifice(s) on the housing 101 to allow for excess water to bypass the damming properties of the housing 101. In some implementations, sizes and heights of the overflow device 107 can be designed to be dependent according to the configuration and requirements of the drain water retention/detention unit 100.

The drain water retention/detention unit 100 includes a master station 120 in communication with the controller 300 to control the operational function of the drain valve 105. The master station 120 acts as a hub and control center to relay or transmit information via wireless or hardwired communication to/from the controller 300 and/or all other drain water retention/detention units. The master station 120 can control the drain valve 105 to open and close per a roof volume capacity plane installed at all units at a specified location(s). Other information includes, but not limited to, current state of precipitation occurrence, atmospheric conditions, retained water level(s) on roof(s) indicated on the roof volume capacity plane, a period of time that water has been retained (stored) on the rooftop since a precipitation even, and/or open or close valve(s) based on predetermined requirements, which include but are not limited to: length of time that water has ponded on the roof without draining, a leak or change in humidity level(s) or dew point identified by the system, and roof inspection or maintenance. In some implementations, the master station 120 can provide atmospheric conditions to tabulate all data or information from a roof of a specific project site.

In some implementations, a solar cell 125 is configured with the drain water retention/detention unit 100 for charging battery(s) to generate power, including wireless communication interface, precipitation/atmospheric sensors, float control monitoring, and/or controlling the drain valve to hold and release stormwater.

In some implementations, a water level sensor valve 130 or a float valve is configured with the drain water retention/detention unit 100. The float valve 130 can be a device that measures stormwater volume or depth of water on any roof surface. In certain implementations, the float valve 130 can also be used for leak detection by determining the reduction of stored stormwater leaving the system and comparing to an expected evaporation of release reductions. It should be appreciated that more than one float valve can be employed as stormwater levels will not likely be consistent from roof surface to roof surface on a project. In some implementations, where roofs that do not require precipitation or atmospheric data, the data collected from the float valve 130 may be used as the basis for communicating with the controller 300 to control monitoring and operating the drain valve to hold and release stormwater. In cases as such, the designated float valve 130 can act as a hub that relays information via wireless communication to/from other drain water retention/detention units 100.

In some implementations, a precipitation and atmospheric condition sensor 140 is configured with the drain water retention/detention unit 100. This sensor 140 is a device that measures precipitation and can measure other atmospheric conditions including, but not limited to; temperature, humidity, wind speed, solar radiation, etc.

In some implementations, a satellite valve (not shown) is configured with the drain water retention/detention unit 100. In this case, the satellite valve is used when there is more than one roof drain, scupper and/or outlet on a roof plane. The satellite valve can operate similarly as the master station by opening and closing at the same time as those units. In some implementations, the satellite valve can be controlled by the master station that can reside on the same plane as the satellite valve. The satellite valve can include the similar housing, bypass overflows, solar cells that charge battery(s) to generate power, wireless communication interface, and an automated valve to hold and release stormwater, as the master station.

The controller 300 may be communicatively coupled to each of the one or more drain water retention/detention units 100 and/or one or more leak detection units 200. In one implementation, the controller 300 may be a computing system that includes a processor and a storage system. The storage system includes software and stored data, including data in database structure. In some implementations, the processor loads and executes software, which is a software application stored in the storage system. The processor can also access data stored in the database in order to carry out the methods and control instructions described herein. Although the controller 300 is depicted as described herein as one, unitary processor and one storage system, it should be appreciated that one or more storage systems and one or more processors, may comprise the controller, which may be a cloud computing application and system. The processor includes a processor, which may be a microprocessor, a general-purpose central processing unit, an application-specific processor, a microcontroller, or any type of logic device. The processor may also include circuitry for retrieving and executing software. It should be appreciated that the processor may be implemented with a single processing device, but may also be distributed across multiple processing devices or subsystems that cooperate in executing software instructions.

The storage system may comprise any storage media, or group of storage media, readable by processor, and capable of storing software and data. The storage system can include volatile and non-volatile, removable and non-removable media implemented in any method or technology for storage of information, such as computer-readable instructions, data structures, program modules, or other data. The storage system may store a set of processor instruction or algorithm, which when executed by the controller 300 enables automated opening and closing of drain valve. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM) and Static Random-Access memory (SRAM).

The controller 300 provides control instructions to each of the one or more drain water retention/detention units 100 and/or one or more leak detection units 200. The control instructions may be individually configured for each of the one or more drain water retention/detention units 100 and/or one or more leak detection units 200.

In some implementations, the controller 300 receives and transmits information/data collected by each of the one or more drain water retention/detention units 100 and/or one or more leak detection units 200 via a relay computing device 110, i.e., receiver/transmitter. The relay computing device 110 can be located in the drain water retention/detention units 100, for example. The computing device 110 may communicate by any wireless communication protocols or means, such as Cellular, LARA, Bluetooth, Wi-Fi, RF transmission, GPS, or the like.

In other implementations, a sensor electronics can include a transmitting device for wireless transmission of information. For example, the transmitting device can be an active, RFID transponder. Alternatively or additionally, it may be provided that the transmitting device includes a near-field communication (NFC) transmitter and/or a global system for mobile communication (GSM) transmitter. Preferably, the transmitting device, especially the active RFID transponder, is designed in such a way that no external activation signal, especially from a receiving device and/or an RFID reader, is required to transmit the information.

It should be understood that the foregoing example embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The example embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written to implement all or a portion of the methods disclosed herein, or as noted it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, DVDs, magnetic tapes and other optical and non-optical data storage devices. The computer readable medium can also be distributed over a network-coupled computer system so that the computer readable code is stored and executed in a distributed fashion.

Now to the discussion of analyzing the roof surface(s) to determine the feasibility of stormwater management on a per project basis. Criteria used to determine the analysis are as follows, but not limited to any of the following variables.

Rooftop stormwater volume capacity: this analysis provides the maximum amount of stormwater that can be collected on a roof surface. When multiple surfaces exist on a project, each surface's volume characteristics are independently tabulated. In order to calculate the volumetric capacity, a geometry of the roof surface must be determined. The geometry can include: a) a combination of surfaces of horizontal roof area(s) and any vertical wall area(s) that in combination contribute to stormwater that encounters a roof(s) surface(s); b) a depth of stormwater that could be collected per structural analysis while meeting all building code requirements; and/or c) a slop of roof.

Roof plumbing and mechanical: this analysis provides the number, location and flow pattern of stormwater for all roof drains on any related roof surface included in the feasibility analysis; and the location, size and type of all rooftop mechanical units on any related roof surface included in the feasibility analysis.

Roof analysis plan: this analysis outlines all roof surfaces for proposed stormwater management which includes: a) rooftop stormwater volume capacity for each proposed roof surface; b) maximum allowable or requested depth of stormwater capacity that is not to exceed a structural analysis; c) location of each roof drain or scupper outlet and the flow of stormwater when it leaves the roof surface, e.g., but not limited to, roof drain or scupper connected to sewer, roof drain or scupper that flows to another roof surface, and roof drain or scupper egressing through to downspout or other method that does not flow into sewer system, or other roof surface, e.g. on-grade landscaped or hardscaped surfaces; d) location of all roof mechanicals; e) location of all drain valves; and location of leak detection units.

Algorithm: pertinent data is entered into the controller 300 that optimizes the total amount of stormwater that can be managed on a roofs surface or a combination of roofs surfaces. In addition to this data, to project with better accuracy to the specific location of the project, local historical atmospheric conditions and local regulations are added into this algorithm. This provides the necessary information that creates a predictive estimation of the total stormwater that will be managed through evaporation over any given duration of time. Variables used to refine this predictability include, but are not limited to the following: 1) local historical atmospheric conditions, e.g., temperature, humidity, wind speed, and solar radiation; 2) roofing manufacturer's allowable time for ponding water on a roofs surface without voiding warranty(s); federal and local regulations and codes, i.e., allowable time as dictated by health codes for stagnant and/or ponding water, e.g. 24 hrs, 48 hrs, 72 hrs, or indefinite; and allowable flow rate of stormwater leaving through the roof drains and/or scuppers, e.g. cubic feet per second (CF/S), cubic meters per second (CM/S), gallons per minute (GPM), etc.; and 3) based on the above analysis, the algorithm calculates the projected stormwater management capacity.

Stormwater management capacity: this analysis measures the projected amount of stormwater managed over a given point of time. This can be a baseline projection used to measure the effectiveness of this system. In some implementations, the information can be provided to a decision maker, e.g., building owner, general contractor, civil engineer, salesperson, etc. to decide on whether a stormwater management system is a viable option for their project. This information can be used to verify that this system is an acceptable arrangement to meet stormwater regulations and/or used to measure value against other green stormwater infrastructure tools. In some implementations, the information supplied with the stormwater management plans can be forwarded to building code officials during the building permitting process.

Now to the process of detecting leaks in the roof, FIGS. 1 and 2 depict the leak detection unit 200 that constantly monitors for presence of water in the roof cavity or underlying portion of the roof surface 60. As shown in FIG. 2, there are two leak detection units 202a, 202b each located below the roof surface 60. Leak detection units 202a is located farther from the drain water retention/detention unit 100, thus detecting leaks at higher elevation of the roof. Leak detection units 202a is located closer to the drain water retention/detention unit 100, thus detecting leaks at lower elevation of the roof, due to the sloping effect of the roof. The above embodiment is solely an example of how leak detection units 202 interact with retention/detention units 100 and is not restricted to a certain number of units per retention/detention unit. Although two units is common per drainage field, as little as one (1) and infinite units could be required per the nuances of any roof design.

In general, when a water leak is detected, the system will automatically open the automated drain valve 105 and flush the collected stormwater present on the roof surface. The leak detection process of the present system provides peace of mind that when a leak would occur on a roofing/waterproofing surface where stormwater is retained, then the retained water is removed as quickly as possible. This safety factor exponentially reduces exposure to both the roofing/waterproofing manufacturers warranting their systems as well as to the building owner by mitigating potential damage of such an event. By way of example, if a retention roof contains stormwater, that stormwater should evaporate at a rate consistent with current atmospheric conditions. In order words, the additional process will check if the retained stormwater is disappearing beyond what the high-end reasonable range for evaporation is, e.g., Death Valley on a 132° sunny day. If this anomaly occurs, it indicates the prescience of a leak, flushes the roof, tabulates the time of the leak and notifies the appropriate parties that the roofing/waterproofing surface has an active breach. As a safety feature, the system will not close until the building owner, or owner's representative resets the system to after the breach is remedied, to safely retain stormwater.

In use, the leak detection process begins by communicating (synchronizing) with master station 120 to communicate with the controller 300. Then, the process checks the roofing cavity at a predetermined time interval to check the consistency of the relative humidity and dew point levels of the roof cavity. For example, if the dew point is constant, no action will be taken. If the dew point increases past an accepted levels as dictated by roofing manufacturing, the process will commence flushing to remove any retained stormwater existing on the roof. Moreover, if at any time the roof cavity indicates breach, leak or change in relative humidity levels or dew point in the waterproof roofing membrane and/or roof cavity, the process will identify the location of the breach, in which the master station 120 on that appropriate roof plane will open the applicable drain valve 105 to release any retained stormwater. Then, the process will require recalibration and synchronization after any breach, leak or change in relative humidity or dew point to reactivate the drain valve.

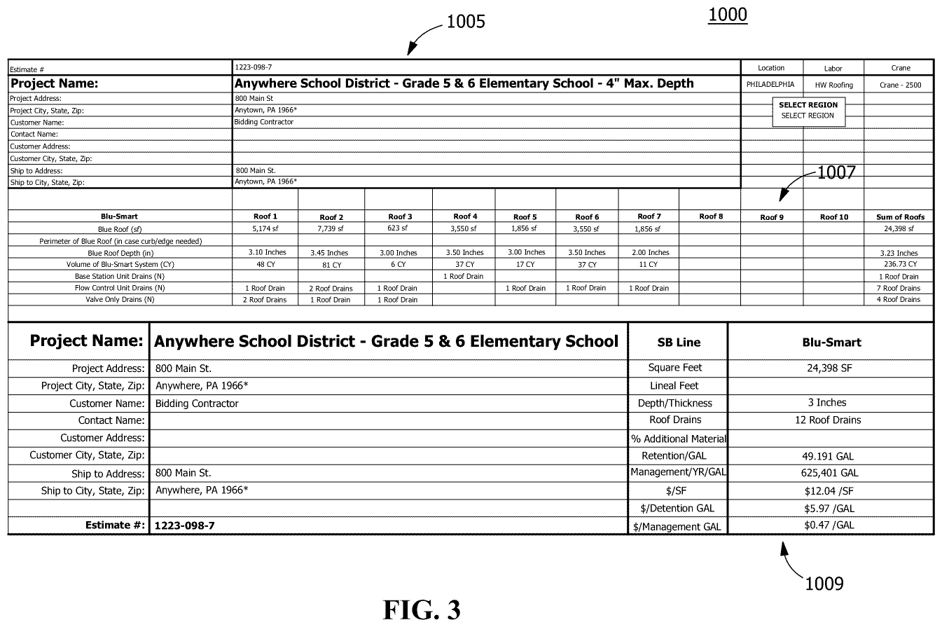

FIG. 3 is a display representation showing an exemplary output of a stormwater management system, according to an example embodiment of the present disclosure. More specifically, a display 1000 that shows prediction from how much stormwater will be managed on a particular project (e.g., Muhlenberg School District-Elementary School). As shown, the display 1000 includes a location display portion 1005 of the roof of the building, an identification of each drain water retention/detention unit (e.g., 100) display portion 1007 that are located on the roof, and a project feasibility analysis display portion 1009. In this example, this project has seven (7) drain water retention/detention units located at predefined locations on the roof (e.g., Roof 1-Roof 7) with a total of 12 roof drains, having a total square footage area of 24,398 SF at a depth of approximately 3.23 inches, defining a total volumetric measurement of 236.73 CY. Based on the pertinent measured data, the system can optimize the total amount of stormwater that can be managed on this particular roof surface. In this case, the system calculated a retention/GAL of 48,191 GAL and a management/YR/GAL of 625,401 GAL. Using these data, the system can tabulate the total amount of stormwater that is actually managed against a prediction or estimate. In addition, the system can show actual predictions with projected costs. In this case, the system projected a Price ($)/SF of $12.04/SF, a Price ($)/detention GAL of $5.97/GAL, and a Price ($)/Management GAL of $0.47/GAL.

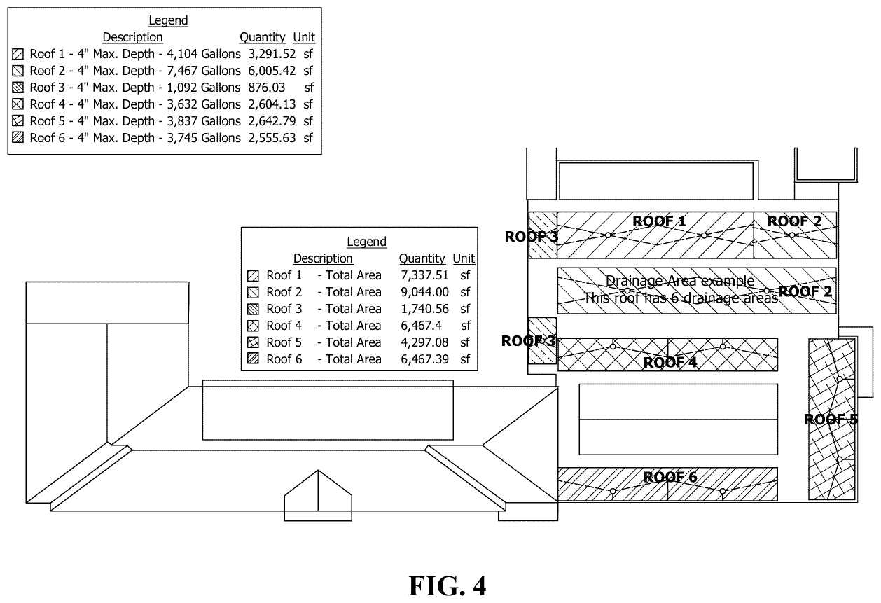

FIG. 4 is a graphical illustration of an exemplary roof surface floor plan displaying the corresponding drainage areas. Each drainage area is designated as “Roof 1” to “Roof 6” in this case. Also shown can be the drains in each of the drainage areas. For example, “Roof 1” drainage area has 2 drains; “Roof 2” drainage area has 3 drains; “Roof 3 drainage area has 2 drains; “Roof 4” drainage area has 2 drains; “Roof 5” drainage area has 2 drains; and “Roof 6” drainage area has 2 drains. Also included in this illustration are total square area of each drainage area, estimated total gallons of stormwater, and maximum depth of stormwater.

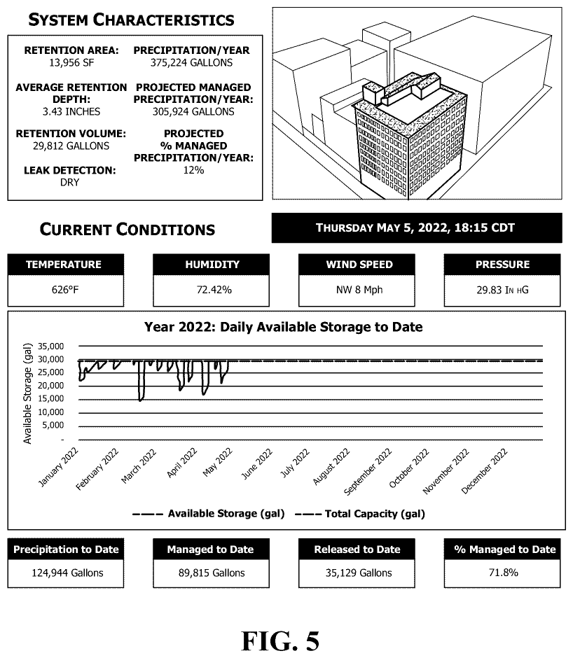

Referring to FIG. 5, additional to the above information, to project with better accuracy to the specific location of the project, local historical atmospheric conditions (FIG. 6) and local regulations are calculated into the stormwater management system. This provides the necessary information that creates a predictive estimation of the total stormwater that will be managed through evaporation over any given duration of time. As shown, FIG. 5 displays system characteristics, such as, retention area, average retention depths, retention volume, indication of leak detection, precipitation/year, projected managed precipitation/year, and projected % managed precipitation/year. Also displayed is the current atmospheric conditions, such as, temperature, humidity, wind speed, and pressure.

As described herein, the term “rooftop stormwater volume capacity” relates to the maximum stormwater volume capacity of single or combined rooftop surface area.

As described herein, the term “structural analysis” relates to a process that determines weight limitations for retained stormwater that identifies the stormwater volume capacity of a roof surface.

As described herein, the term “rooftop stormwater volume management capacity: ” relates to a combination of multiple variables that include, but are not limited to; rooftop stormwater volume capacity, available depth to retain stormwater, location, government regulations and discharge locations for stormwater.

As described herein, the term “stormwater management capacity” relates to a projected amount of stormwater managed over a given point of time.

As described herein, the term “roof section” relates to a roof area that is separated from other roof areas or where roof drain inlets are at different levels.

As described herein, the term “roof cavity” relates to components of a roofing system that include, but are not limited to waterproofing roofing membrane, coverboard, insulation, air barrier, vapor barrier, etc.

As described herein, the terms “green roof,” “living roof,” or “eco-roof” relate to a roofing system where a layer of vegetation is planted over a waterproofing membrane on top of a building. For example, treating storm water by storing it in the growing media and releasing it back into the hydrologic cycle through evapotranspiration.

As described herein, the term “grey roof harvesting” refers to the practice of collecting and utilizing wastewater (greywater) from indoor plumbing systems, excluding toilet water, for non-potable purposes like irrigation. For example, grey water harvesting systems utilize storm water for property and building systems that do not require potable water (i.e. irrigation, toilet flushing, car wash).

As described herein, the term “blue roof” relates to a rooftop design that captures and stores rainwater for later use or slow release, effectively managing stormwater runoff. For example, blue roofs are systems of weirs installed throughout the roof that slow the discharge of the storm water by extending the time it takes to get to the roof drain.

As described herein, the term “Blu-Smart roof analysis plan” refers to a plan that the provides the locations of the roof surfaces proposed to manage stormwater, their stormwater volume capacity(s), available stormwater depth(s), roof mechanical location(s), locations of all roof drain and scupper outlet and the flow rates and destination of all stormwaters leaving the roof.

As described herein, the term “Green Stormwater Infrastructure (GSI)” refers to a way to manage stormwater runoff that mimics natural systems to filter and reduce the amount of water that enters sewer systems. GSI uses man-made volume containment devices, plants, soil, and stone to treat stormwater at its source, and can also reduce flooding and improve air and water quality.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of.”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system for releasing stormwater on a rooftop of a building structure, comprising:
at least one drain water retention unit including a float control device to measure volumetric stormwater retained in the rooftop and a valve to operatively open a drain when the measured volumetric stormwater is exceeded;
at least one leak detection unit configured to detect a water leak, located under an underlying surface of the rooftop, the at least one leak detection unit detects the leak in response to change in relative humidity levels or dew point under the underlying surface of the rooftop; and
a controller, executing control instructions, in communication with the at least one drain water retention unit for selectively controlling the valve in accordance with the control instructions, the controller includes a storage associated with the controller for storing the control instructions,
wherein the control instructions are performed according to the steps of:
measuring the volumetric stormwater retained in the rooftop;
determining a duration of time of stormwater retained in the rooftop;
determining a location of the building structure to provide prior estimated precipitation and atmospheric conditions, defining a predefined allowable tolerance; and
comparing the measured volumetric stormwater with the predefined allowable tolerance and, if the measured volumetric stormwater exceeds the predefined allowable tolerance, opening the drain to remove the stormwater.

2. The system according to claim 1, wherein the measured volumetric stormwater is measured by the roof surface and its corresponding depth and a slope of the roof.

3. The system according to claim 1, wherein the duration of time for retaining stormwater is at least one of 24 hours, 48 hours, 72 hours, or indefinite.

4. The system according to claim 3, wherein the duration of time for retaining stormwater is 72 hours.

5. The system according to claim 1, wherein the prior estimated precipitation and atmospheric conditions includes at least one of temperature, solar radiation, wind speed, and humidity.

6. The system according to claim 1, further comprising a precipitation/atmospheric sensor to measure current precipitation or atmospheric conditions, the precipitation/atmospheric sensor located on the at least one drain water retention unit, wherein the controller executes control instructions to operate the drain based on the measured current precipitation or atmospheric conditions.

7. The system according to claim 1, wherein the at least one drain water retention unit is operated by a solar cell that charges a rechargeable battery installed on the at least one drain water retention unit.

8. The system according to claim 7, wherein the solar cell charges at least one of a wireless communication interface, the drain valve, the float control device or a precipitation/atmospheric sensor

9. The system according to claim 1, wherein the control instructions are performed according to further steps of:
determining a health code regulation for retained stormwater; and
comparing the measured volumetric stormwater with the health code regulation and, if the measured volumetric stormwater fails the health code regulation, opening the drain to remove the stormwater.

10. The system according to claim 1, wherein the control instructions are performed according to further steps of:
calculating an evaporation rate for the measured volumetric stormwater and, if the calculated evaporation rate of the measured volumetric stormwater exceeds a predefined amount at a predetermined period of time, opening the drain to remove the stormwater.

11. The system according to claim 1, wherein the control instructions are performed according to further steps of:
measuring the relative humidity or dew point under the underlying surface of the rooftop at selected interval for anomalous humidity/dew point variables, wherein:
if the measured humidity/dew point is constant, leaving the drain closed and retain the stormwater; and
if the measured humidity/dew point is greater than past accepted levels, opening the drain to remove the stormwater.

12. The system according to claim 1, wherein the drain is opened/closed based on at least one of: a length of time that stormwater retained on the roof surface without draining, a change in relative humidity or dew point, and an inspection/maintenance requirement.

13. The system according to claim 1, wherein the control instructions are performed according to further steps of:
measuring wave measurements via the float control device located on the at least one drain water retention unit; and
identifying the location of the leak in response to the measured wave measurements,
wherein if a leak is identified, a higher waver measurement is measured.

14. The system according to claim 1, wherein the control instructions are performed according to further steps of:
measuring an evaporation rate of the retained stormwater; and
comparing the measured evaporation rate with an evaporation rate consistent with current atmospheric conditions and, if the measured evaporation rate exceeds a threshold, opening the drain to remove the stormwater.
